(19) United States
(12) Patent Application Publication
(10) Pub. No.: US 2011/0073642 A1
(43) Pub. Date: Mar. 31, 2011

(54) CUSTOMER INTERACTION MANAGEMENT FOR AN AUTOMATED INTERACTIVE CUSTOMER INTERFACE FOR AN AUTOMOTIVE FACILITY

(76) Inventor: Tim Yablonowski, Naples, FL (US)

(21) Appl. No.: 12/568,564

(22) Filed: Sep. 28, 2009

(51) Int. Cl. G06F 17/00

(52) U.S. Cl. 235/380; 235/375

(57) ABSTRACT

A system for interacting with onsite customers at an automotive facility when operating personnel normally present at the facility are not present, such as after hours. The system may comprise a free-standing kiosk having a data input interface device and data processing capabilities. The data processing capabilities may enable a customer to initiate transactions such as service transactions, lease transactions, and purchase transactions. The automotive facility may have an onsite server linked to the kiosk but located out of view therefrom. The kiosk and onsite server may be connected to the internet and may be functional to conduct transactions in whole or in part over the internet.

### REFERENCE TO RELATED APPLICATION

The present application is related to a copending application entitled FACILITIES MANAGEMENT FOR AN AUTOMATED INTERACTIVE CUSTOMER INTERFACE FOR AN AUTOMOTIVE FACILITY, filed of even date herewith. The copending application is hereby incorporated in its entirety herein by reference.

### FIELD OF THE INVENTION

The present invention relates to an automated system for managing and expediting customer interaction in an automotive sales and service facility which may be unstaffed at times when customers are present, where a customer or potential customer seeks to prepare for sales, lease, and automotive service transactions using the unmanned facility, and for performing administrative tasks in support of sales, lease, and automotive transactions.

### BACKGROUND OF THE INVENTION

Automobile dealerships ordinarily maintain set business hours during which personnel are present to serve customers. Salespeople, service technicians, financial specialists, and service advisors may ordinarily be present at the facility during normal business hours but not present outside the usual hours. After hours visits of potential customers, aside from some service customers who choose to leave their automobiles and keys at such facilities, are pointless. Yet a number of potential customers of new and old automobiles and even for repair and maintenance services could be accommodated if there existed a suitable way to communicate with such potential customers. Doing this would potentially significantly increase the volume of business and profitability of an automotive facility.

There exists a need in the industry to accommodate additional after hours contact with potential customers. There also exists a need for a recognizable place to initiate or conduct business after hours at an automotive facility.

### SUMMARY OF THE INVENTION

The present invention provides apparatus to enable customers and potential customers to initiate transactions at an automotive facility such as an automobile dealership at times when the usual personnel are not at the facility, such as after normal business hours. Transactions, which may pertain to purchases and leases of automobiles or to repair and maintenance services, may be initiated using an automated data processing device. The automated data processing device may be a free-standing kiosk, and may have data input thereto using a touch screen or the like. A free-standing kiosk may be visually recognizable as a contact point for after hours business and may spur additional business at a facility provided therewith.

The automated data processing device may accept basic information such as identity of a customer and the nature of the customer's inquiry or transaction. Certain aspects of inquiries and transactions may be fulfilled using the automated data processing device, such as obtaining estimates of repair costs, leasing charges, and other costs relating to standard services. An offer by a customer to buy a new or old automobile may be accepted at the automated data processing device for presentation to the appropriate terminal of staff for processing when business hours resume. Certain potential activities may be scheduled, such as conducting test drives of automobiles and obtaining appraisals for automobiles which may be sold to the automotive facility.

The automated data processing device may be connected to a server located on the premises of the automotive facility but remote therefrom. The server and the automated data processing device may be connected to the internet so that transactions which have been initiated at the premises may be continued or concluded remotely.

It is an object of the invention to provide a way for on-premises customers and potential customers to initiate sales and service related transactions with an automotive facility.

Another object of the invention is to readily retrofit an existing automotive facility with apparatus to enable automated contact and data transfer in support of after hours sales and service related transactions.

A further object is to facilitate remote communications in support of sales and service transactions which have been initiated onsite at an automotive facility.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of a representative automotive facility which may comprise a customer interface system according to at least one aspect of the invention.

FIG. 2 is a perspective detail view, drawn to enlarged scale, of an interface device seen generally at the center of FIG. 1, together with a portable enablement device which is typically carried on the person of a customer, according to at least one aspect of the invention.

FIG. 3 is a functional diagram of components of the novel customer interface system, according to at least one aspect of the invention.

FIG. 4 is a block diagram of steps of a method according to at least one aspect of the invention.

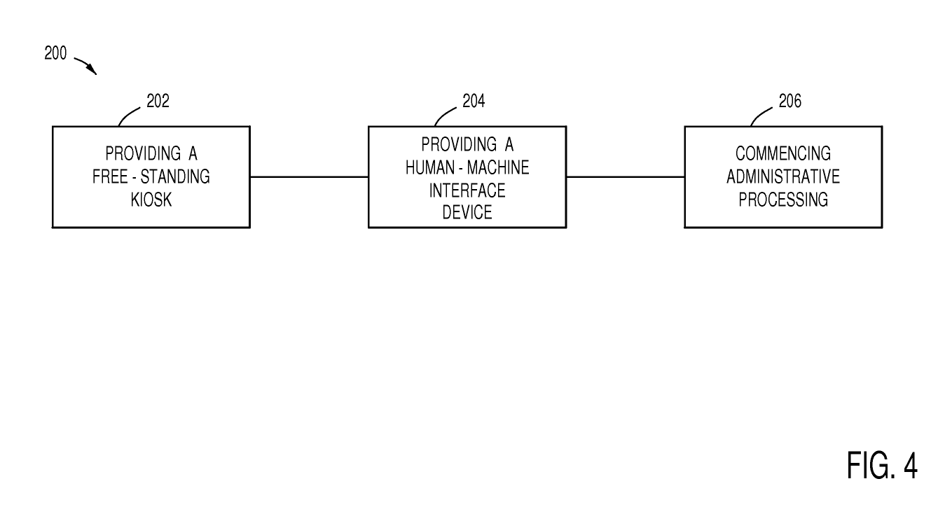

### DETAILED DESCRIPTION

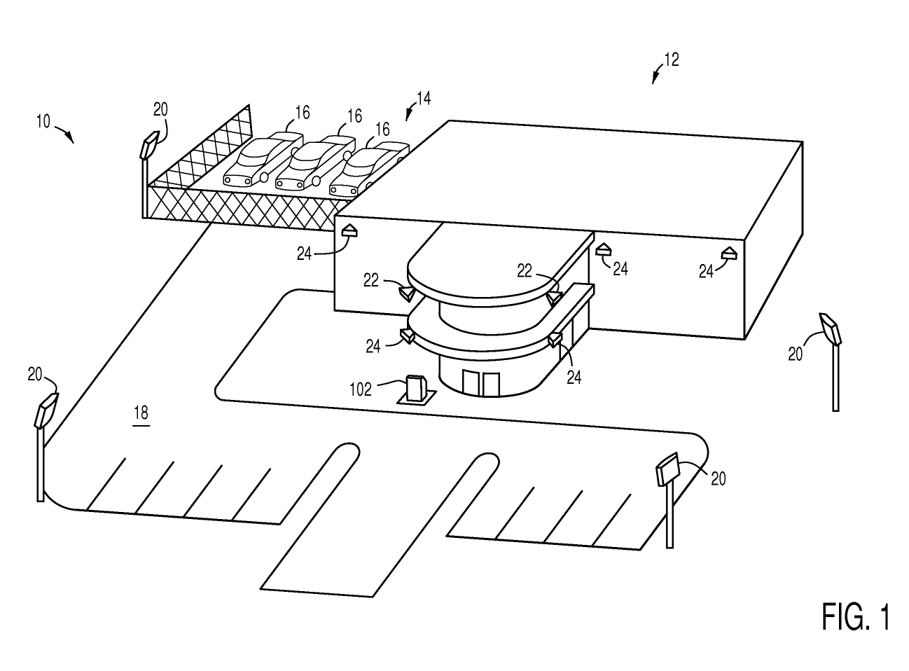

Referring first to FIG. 1, according to at least one aspect of the invention, there is shown an automotive facility 10 which is representative of automobile dealerships and service facilities. The automotive facility 10 may have a building 12 where business is conducted, a lot 14 on which vehicles 16 are stored and displayed for sale and lease or for repair and maintenance services, and interior space (not separately shown) within the building 12 for performing maintenance and repair services. The automotive facility 10 may have a paved parking lot and driveway 18 which potential customers may use to park their automobiles while browsing for a new or old automobile to buy or lease, or while arranging for service or to buy replacement parts. The building 12, the lot 14, and the parking lot and driveway 18 may be illuminated at night by overhead lighting fixtures 20.

The automotive facility 10 may have one or more speakers 22 and one or more sensors such as motion detectors 24 for detecting the presence of people entering onto the premises.

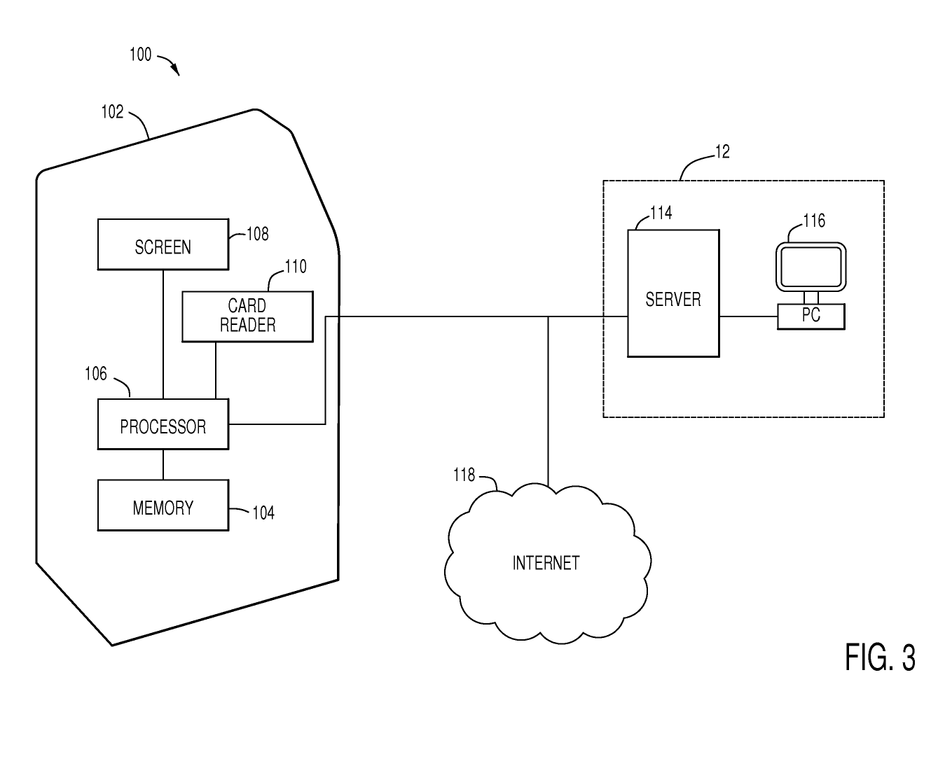

According to at least one aspect of the invention, there is provided a customer interface system 100 for conducting automotive transactions in part or in their entirety at the automotive facility 10 when the automotive facility 10 is unstaffed, such as after ordinary business hours. The customer interface system 100, shown functionally in FIG. 3, may comprise a customer operable automated transaction processor which may be in the form of the free-standing kiosk 102 having a memory device 104 (hereinafter referred as a memory for brevity) and a data processor 106. The memory 104 and the data processor 106, both shown in only representative capacity and not literally, will be understood to encompass all types of memory, supporting hardware and software, and connections to other components of the customer interface system 100 to be operable as described. For brevity, the data processing components of the kiosk 102 and data handling processes enacted thereby, acting individually or collectively, may be referred to as the kiosk 102. The kiosk 102 is disposed to conduct a commercial transaction at least in part for at least one of an automobile purchase transaction and an automobile service transaction. As employed herein, the term “purchase transaction” will be understood to encompass both actual sales where legal possession passes from one party to another, and also lease transactions wherein a customer enters into an arrangement to lease an automobile through the automotive facility 10.

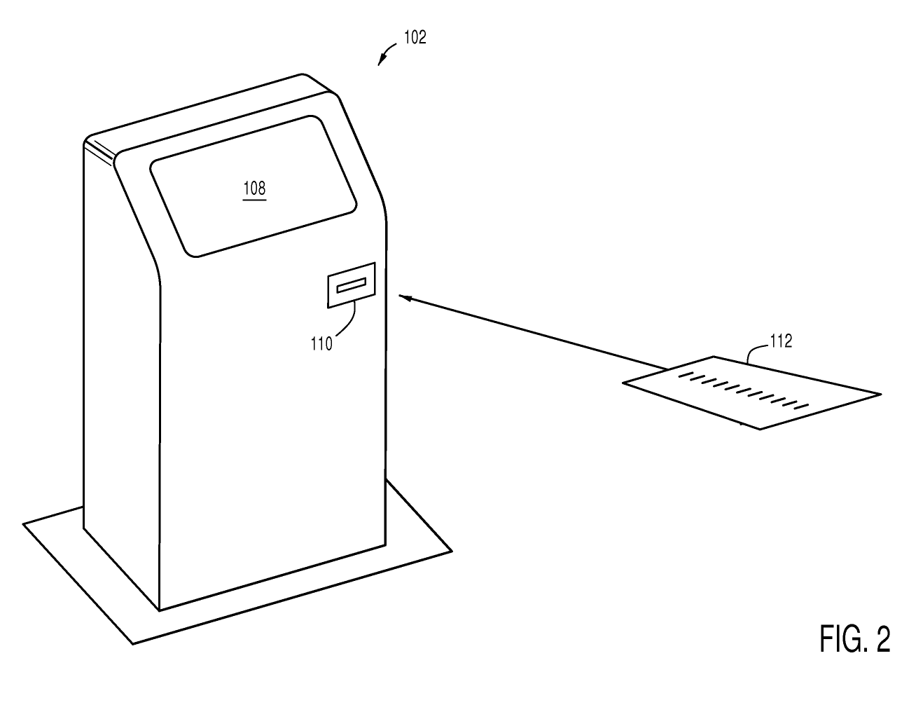

As depicted in FIG. 2, the kiosk 102 is free-standing in that it may be mounted to any suitable environmental surface and may be unattached to the building 12 or other structure. In free-standing form, the kiosk 102 may conveniently be manufactured and installed on the premises of the automotive facility 10 as a modular unit, requiring only mounting in place and connection of communication and electrical power cables (not shown) to become functional. However, it should be understood that the kiosk 102 may take other forms and be installed on the premises of the automotive facility 10 in other ways. For example, a functionally similar kiosk (not shown) may project laterally from a vertical wall of the building 12, may depend from a soffit surface of the building 12, or may span two or more environmental surfaces of the premises, such as any of a vertical wall, soffit, or ground or floor surface. A functionally similar kiosk may be integrated into the premises so as not to be visually discernible as a discrete object unto itself, unlike the kiosk 102.

Shown in greater detail in FIG. 2, the kiosk 102 may further comprise a human-machine interface device such as a touch screen 108 which is disposed to enter data into the memory device 104 and data processor 106. The touch screen 108 may be disposed to receive data inputs from a customer responsive to the customer touching the touch screen 108 selectively at predetermined locations thereon, as is known.

The touch screen 108 may be integral with a display screen which displays data pertaining details of that transaction which is being conducted by the customer. The kiosk 102 will be understood to include data processing hardware and software which are functional to enter data related to identity of a customer and to enter data related to that one of the automobile purchase transaction and the automobile service transaction being conducted by the customer. A transaction may be one transaction or plural transactions. The kiosk 102 may comprise a reader 110 capable of reading data from a portable device such as a machine readable identity card 112 bearing a unique account identifying data sequence. The machine readable identity card 112, shown in FIG. 2, may be of the type commonly used as debit and credit cards or for authorized entry systems (not shown), for example.

The kiosk 102, which serves as a human-machine interface device for enabling communication between a customer and the system 100, may comprises a manual data entry device other than the touch screen 108. The manual data entry device may comprise a keypad or keyboard, or may communicate wirelessly with a mobile communications device such as a cellular telephone, personal digital assistant, or the like (none of these options is shown).

Referring specifically to FIG. 3, the system 100 may comprise a database server 114 located on the premises of the automotive facility 10, but remotely from the kiosk 102. The database server 114 may be located at a concealed location within the building 12 for example. The automotive facility 10 may also include one or more computer terminals (shown representatively as a single personal computer 116). The database server 114, the personal computer 116, and the kiosk 102 may be communicably and functionally linked to one another and may be connected to an external communications channel such as the internet 118. Thus the kiosk 102 and the database server 114 are each disposed in communication with and are therefore accessible through the internet 118. The database server 114 may have memory and processing capabilities which are supplemental to the kiosk 102, as will be described hereinafter.

The automotive facility 10, apart from the system 100, may be generally conventional, having in addition to the physical apparatus described above, at least one service technician, at least one sales person, and other personnel, optionally including managers, service advisors, financial specialists, and others (not shown). Any of these personnel may be provided with a computer terminal such as the personal computer 116.

The kiosk 102 may be configured and enabled to conduct any and all of the following types of transactions. The kiosk 102 may be disposed to receive and store data requesting at least one repair service for a particular automobile, and to authorize a repair service to be conducted by a service technician of the automotive facility responsively to entry of an authorized request for at least one repair service. The kiosk 102 may have capability of transmitting directions to the customer pertaining to a location at the automotive facility 10 where automobiles are to be left unattended for subsequent service, and to a location at the automotive facility 10 where keys are to be left. Directions may appear on the touch screen 108, or alternatively or in addition, may be provided in audible form using the speakers 22. The kiosk 102 may be functional to display a list in written form of routine maintenance services and associated standard charges for the routine maintenance services.

The kiosk 102 may comprise data processing hardware and software which are disposed to receive and store data pertaining to a sales inquiry to purchase an automobile. Data pertaining to a sales inquiry may include for example characteristics of automobiles maintained in inventory at the automotive facility 10, such as images showing the appearance of any automobile in inventory, the list price of such automobile, a stock number which may be assigned to that automobile, age and mileage of that automobile, which would come into play usually for old automobiles, vehicle identification number assigned by the manufacturer, identity of any particular sales personnel who may have particular sales responsibility or authority for that automobile, if such delegation of authority is made by the automotive facility 10, and the like.

Some transactions are for standard services. For example, many routine operations such as engine oil changes, drive belt replacement, wheel balancing, state or federally mandated inspections, and the like, entail predetermined labor, parts, and materials charges, and thus may have predetermined total charges. These charges may be annunciated to customers at the kiosk 102 for example. Where total charges are predetermined, either precisely or within a predetermined range (i.e., certain maintenance and repair operations may be estimated at a particular charge within a predetermined deviation, such as plus or minus ten percent), the kiosk 102 may be disposed to accept payment for such operations. The reader 110 may, in addition to merely recognizing customer identity, comprise a payment acceptance apparatus for accepting prepayment of predetermined services. The reader 110 may for example comprise a credit or debit card processor of known type.

The touch screen 108 or other manual control such as a keypad if provided (not shown) may be configured to cause a fillable form for accepting data pertaining to that one of the automobile purchase transaction and the automobile service transaction being conducted by the customer to be displayed. The fillable form may display discrete blank spaces each disposed to accept data inputs from the customer by operating the touch screen 108 or corresponding human-machine interface device.

The kiosk 102 may be functional to display a screen dedicated to an application for credit based on data entered by a customer using the kiosk 102.

The kiosk 102 may be functional to accept input of an offer by a customer to purchase an automobile by entry of data by the customer at the kiosk 102, and to transmit the input offer to the personal computer 116 or corresponding devices (not shown) which may be located in the occupied spaces of the automotive facility 10.

The kiosk 102 may be functional to authorize a lease agreement under predetermined conditions including charges which have been set by the automotive facility 10. Authorizing a lease agreement may comprise for example, assessment of credit standing of the customer, identification of availability of an automobile for the proposed lease, placing an available automobile on a reserved or restricted status which may be signaled to other personnel of the automotive facility 10 who may be investigating other possible lease arrangements with other customers, and like internal processing, even if physical delivery of the automobile is not made at the time the customer conducts this transaction at the kiosk 102.

The kiosk 102 may be functional to calculate monthly payments which would result from particular purchase and lease charges, and to display calculated monthly payments at the display screen 108 of the kiosk 102.

The kiosk 102 may be functional to process inputs by a customer to schedule a test drive of an automobile which is in the inventory of the automotive facility 10.

The kiosk 102 may be functional to process inputs by a customer to schedule an appraisal for a prospective vehicle to be traded as part of a transaction.

The kiosk 102 may be functional to process inputs by a customer to schedule completion of a transaction at a future date or time.

It will be appreciated that whereas some aspects of a transaction may be initiated and completed using the kiosk 102, other aspects thereof may require processing which cannot or may be deemed undesirable to complete at the time a customer initiates that transaction. Because the kiosk 102 and the database server 114 are connected to the internet 118, some transactions may be completed remotely from the premises of the automotive facility 10 after having been initiated at these premises. For example, a customer may complete a transaction from home using an internet connection to his or her personal computer (not shown).

The invention may be regarded a method 200 of operating a customer interface system, such as the system 100, for conducting automotive transactions at an automotive facility which is unstaffed, such as the automotive facility 10. Steps of the method may rely on apparatus which has been presented herein, such as the apparatus shown in FIGS. 1-3 and described above. The method 200 may comprise a step 202 of providing at an automotive facility a free-standing kiosk which is accessible to and operable by a drive-up customer to enter data thereinto, wherein the data pertains to at least one of an automobile purchase transaction and an automobile service transaction.

The method 200 may comprise a step 204 of providing as part of the free-standing kiosk a human-machine interface device disposed to receive, enter into memory, and process data entered by a person at the human-machine interface device.

The method 200 may comprise a step 206 of commencing administrative processing of the at least one of an automobile purchase transaction and an automobile service transaction responsive to data entered using the human-machine interface device by the customer at the free-standing kiosk. Aspects of the selected transaction may be accomplished using the novel apparatus and method steps detailed herein, and may be supplemented by conventional apparatus and method steps.

Although the invention has been described in terms of certain components being referred to in either the singular or the plural, other arrangements are possible. For example, it is to be understood that due to the conceptual description presented herein, components presented in the singular may be provided in the plural. Illustratively,

The present invention is susceptible to modifications and variations which may be introduced thereto without departing from the inventive concepts. For example

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A customer interface system for conducting automotive transactions at an automotive facility which is unstaffed, comprising:
a customer operable automated transaction processor having a memory and a data processor, wherein the automated transaction processor is disposed to conduct a commercial transaction at least in part for at least one of an automobile purchase transaction and an automobile service transaction, wherein the automated transaction processor further comprises a human-machine interface device disposed to enter data into the automated transaction processor, data processing hardware and software functional to enter data related to identity of a customer and to enter data related to that one of the automobile purchase transaction and the automobile service transaction being conducted by the customer, and a display screen disposed to display details of that one of the automobile purchase transaction and the automobile service transaction being conducted by the customer.

2. The customer interface system of claim 1, wherein the customer recognition device comprises a reader capable of reading data from a machine readable identity card bearing a unique account identifying data sequence.

3. The customer interface system of claim 1, wherein the human-machine interface device comprises a touch screen disposed to receive data inputs from a customer responsive to the customer touching the touch screen selectively at predetermined locations thereon.

4. The customer interface system of claim 1, wherein the human-machine interface device comprises a free-standing kiosk comprising a manual data entry device.

5. The customer interface system of claim 1, wherein the automotive facility maintains on staff at least one service technician, and the automated transaction processor is disposed to receive and store data requesting at least one repair service for a particular automobile, and to authorize a repair service to be conducted by a service technician of the automotive facility responsively to entry of an authorized request for at least one repair service.

6. The customer interface system of claim 5, wherein the automated transaction processor of the free-standing kiosk has capability of transmitting directions to the customer pertaining to a location at the automotive facility where automobiles are to be left unattended for subsequent service, and to a location at the automotive facility where keys are to be left.

7. The customer interface system of claim 5, wherein the free-standing kiosk comprises payment acceptance apparatus for accepting prepayment of predetermined services.

8. The customer interface system of claim 5, wherein the automated transaction processor of the free-standing kiosk is functional to display a list in written form of routine maintenance services and associated standard charges for the routine maintenance services.

9. The customer interface system of claim 1, wherein the automotive facility maintains on staff at least one salesperson, and the automated transaction processor comprises data processing hardware and software which are disposed to receive and store data pertaining to a sales inquiry to purchase an automobile.

10. The customer interface system of claim 9, wherein the automated transaction processor comprises data processing hardware and software which store data including characteristics of automobiles maintained in inventory at the automotive facility.

11. The customer interface system of claim 9, wherein the automated transaction processor comprises a manual control at the screen which said manual control causes the screen to display a fillable form for accepting data pertaining to that one of the automobile purchase transaction and the automobile service transaction being conducted by the customer, wherein the fillable form displays discrete blank spaces each disposed to accept data inputs from the customer by operating the human-machine interface device.

12. The customer interface system of claim 11, wherein the automated transaction processor is functional to display a screen dedicated to an application for credit based on data entered by a customer using the human-machine interface device.

13. The customer interface system of claim 9, wherein the automated transaction processor is functional to accept input of an offer by a customer to purchase an automobile by entry of data by the customer at the human-machine interface device and to transmit the input offer in occupied spaces of the automotive facility.

14. The customer interface system of claim 9, wherein the automated transaction processor is functional to authorize a lease agreement under predetermined conditions including charges which have been set by the automotive facility.

15. The customer interface system of claim 9, further comprising a database server communicably and functionally linked to the automated transaction processor, wherein the database server is located at the automotive facility and has memory and processing capabilities which are supplemental to the automated transaction processor.

16. The customer interface system of claim 1, wherein the automated transaction processor is disposed in communication with and accessible through the internet.

17. The customer interface system of claim 16, wherein the database server of the automotive facility is in communication with and accessible through the internet.

18. The customer interface system of claim 9, wherein the automated transaction processor is functional to calculate monthly payments which would result from particular purchase and lease charges, and to display calculated monthly payments at the display screen of the customer interface system.

19. The customer interface system of claim 9, wherein the automated transaction processor is functional to process inputs by a customer at the human-machine interface device to schedule a test drive of an automobile which is in the inventory of the automotive facility.

20. The customer interface system of claim 9, wherein the automated transaction processor is functional to process inputs by a customer at the human-machine interface device to schedule an appraisal for a prospective vehicle to be traded as part of a transaction.

21. The customer interface system of claim 9, wherein the automated transaction processor is functional to process inputs by a customer at the human-machine interface device to schedule completion of a transaction.

22. A method of operating a customer interface system for conducting automotive transactions at an automotive facility which is unstaffed, comprising the steps of:
providing at an automotive facility a free-standing kiosk which is accessible to and operable by a drive-up customer to enter data thereinto, wherein the data pertains to at least one of an automobile purchase transaction and an automobile service transaction;
providing as part of the free-standing kiosk a human-machine interface device disposed to receive, enter into memory, and process data entered by a person at the human-machine interface device; and
commencing administrative processing of the at least one of an automobile purchase transaction and an automobile service transaction responsive to data entered using the human-machine interface device by the customer at the free-standing kiosk.
